(19) United States
(12) Patent Application Publication
(10) Pub. No.: US 2016/0286358 A1
(43) Pub. Date: Sep. 29, 2016

(54) NAVIGATIONAL AID

(71) Applicants: Edward Weiss, Voorhees, NJ (US); Caryn Weiss, Voorhees, NJ (US)

(72) Inventors: Edward Weiss, Voorhees, NJ (US); Caryn Weiss, Voorhees, NJ (US)

(21) Appl. No.: 14/884,230

(22) Filed: Oct. 15, 2015

Related U.S. Application Data
(60) Provisional application No. 62/230,354, filed on Jun. 4, 2015.
(60) Provisional application No. 62/177,827, filed on Mar. 24, 2015.

(51) Int. Cl. H04W 4/02; H04W 4/14; H04M 1/725; G01C 21/20

(52) U.S. Cl. CPC H04W 4/027; G01C 21/20; H04W 4/14; H04M 1/72527

(57) ABSTRACT

Systems, devices, and methods for guiding a client device user toward a host device, which may include receiving, by positioning circuitry of a client device, position information regarding a position of a host device and activating a display of the client device, in response to receiving the position information, to display an indicator representing a direction toward the host device and distance between the host device and the client device based on the position information. The indicator may include a pointer having an orientation in the direction toward the host device and a length corresponding to the distance between the host device and the client device. The host device may communicate with a bridge device via a particular wireless communications standard, and the bridge may relay such communications to client devices via another wireless communications standard with which the host device is not equipped.

### CROSS REFERENCE TO RELATED APPLICATIONS

This application claims the benefit of U.S. provisional application No. 62/177,827 filed Mar. 24, 2015, and 62/230,354 filed Jun. 4, 2015, which are incorporated by reference as if fully set forth herein.

### FIELD OF INVENTION

The invention relates generally to electronic communication and in particular to wireless electronic tracking, direction finding, ranging, and telecommunications.

### BACKGROUND

Children are naturally curious and active. Accordingly, parents and other caretakers have always found it challenging to keep track of their children in public places, such as playgrounds, markets, or other crowded or confusing environments. Caught up in the moment, children too may find themselves unintentionally separated from and unable to immediately determine how best to return to their caregiver.

These situations may be highly stressful for both caregivers and children alike, and unfortunately all too common. Accordingly, it may be desirable to provide a way for children to find their way back to a parent or guardian. It may also be desirable to provide a way for a parent or guardian to monitor the location of a child, or of several children.

There are many other scenarios where it may be advantageous to provide a way for individuals to find their way back to another designated individual or location. Such scenarios may include hiking parties, assisted living facilities, mining operations, and other cases where finding a way back to a host point may be important.

### SUMMARY

Some embodiments provide a system for guiding a client device user toward a host device. The system may include a host device comprising a first wireless transceiver and a first display, a client device comprising a second wireless transceiver, a second display, and an attachment mechanism. The host device may be in wireless communication with the client device over a communications channel. The host device may further include circuitry configured to receive, via the first wireless transceiver, first position data regarding a client device position. The host device may further include circuitry configured to activate the first display, in response to the first position data being received by the host device, to show an indication of the client device on the display which indicates a relative direction and distance of the client device from the host device based on the first position data. The client device may further include circuitry configured to receive, via the second wireless transceiver, second position data regarding a host device position. The client device may further include circuitry configured to activate the second display, in response to the second position data being received by the client device, to show an indication of a relative direction and distance of the host device from the client device based on the second position data. The indication of the relative direction and distance of the host device from the client device may include a pointer having an orientation toward the host device and a length corresponding to a relative distance between the client device and the host device. The client device may further include circuitry configured to activate the display, in response to the second position data indicating a change in the relative direction of the host device from the client device, to change an orientation of the pointer toward the host device. The client device may further include circuitry configured to activate the display, in response to the second position data indicating a change in the relative distance of the host device from the client device, to change a length of the pointer, wherein the length is decreased if the relative distance is decreased and wherein the length is increased if the relative distance is increased. Some embodiments provide a device for guiding a client device user toward a host device. The device may include an antenna, a non-transitory computer readable medium, and a display. The device may further include wireless transceiver circuitry configured to communicate with a host device via the antenna over a communications channel. The device may further include positioning circuitry configured to receive host device position information. The positioning circuitry may be further configured to activate the display, in response to receiving the host device position information, to display an indicator representing a relative direction and distance of the host device from the client device on the display based on the host device position information. The indicator may include a pointer having an orientation in a direction toward the host device and a length corresponding to a relative distance between the client device and the host device.

Some embodiments provide a method for guiding a client device user toward a host device. The method may include receiving, by positioning circuitry of a client device, position information regarding a position of a host device. The method may further include activating a display of the client device, in response to receiving the position information, to display an indicator representing a direction toward the host device and distance between the host device and the client device based on the position information. The indicator may include a pointer having an orientation in the direction toward the host device and a length corresponding to the distance between the host device and the client device.

Various other embodiments will also be evident from the description provided herein.

### BRIEF DESCRIPTION OF THE DRAWING(S)

A more detailed understanding may be had from the following description, given by way of example in conjunction with the accompanying drawings wherein:

FIG. 1 is a front view of an example host device;

FIG. 2 is a front view of an example client device;

FIG. 3 is a system diagram of an example user device, such as a host device or a client device;

FIG. 4 is a front view of an example client device showing a lengthened indicator;

FIG. 5 is a front view of an example client device showing a shortened indicator;

FIG. 6 is a system diagram of an example communications system in which one or more disclosed embodiments may be implemented;

FIG. 7 is a plan view of an example bridge device;

FIG. 8 is an exploded view of an example assembly of a bridge device 700 and a host device; and

FIG. 9 is a flow chart illustrating an example method for guiding a client device user toward a host device using an indicator.

### DETAILED DESCRIPTION OF THE PREFERRED EMBODIMENT(S)

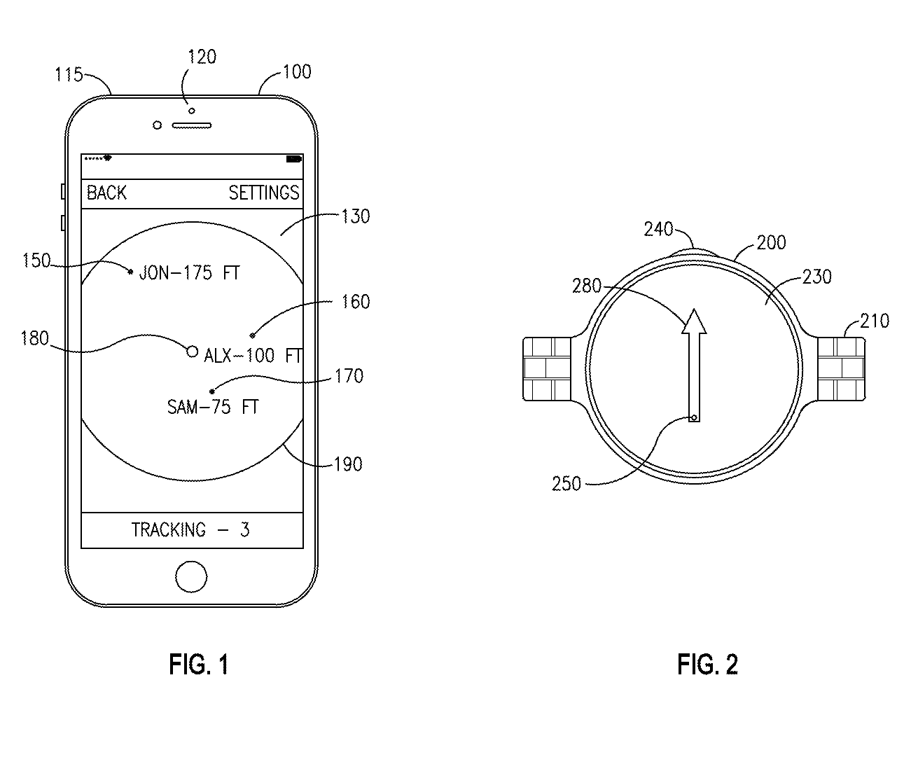

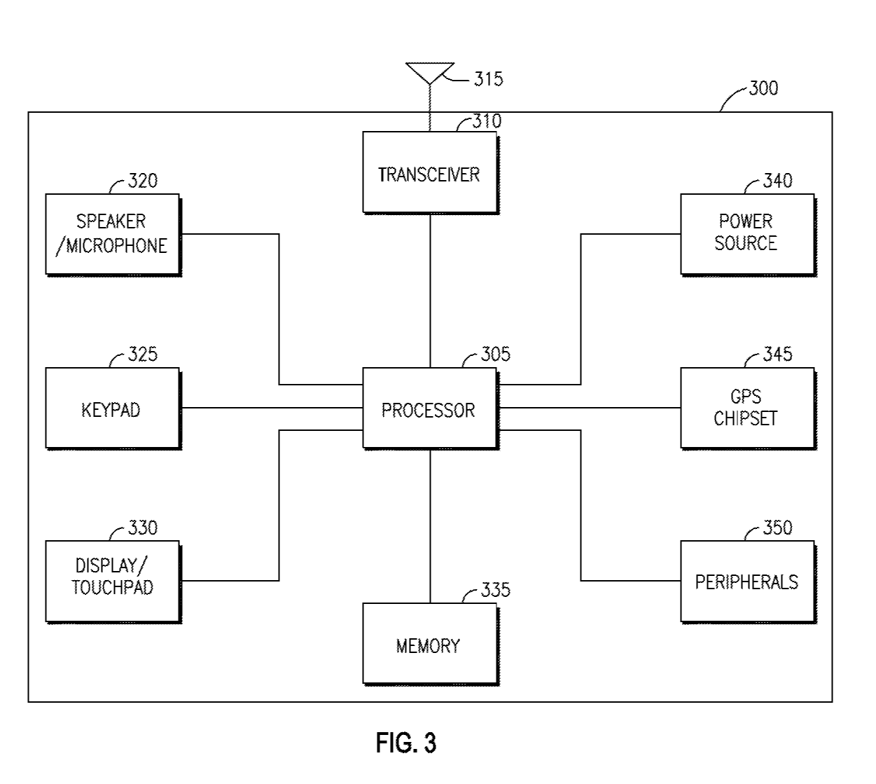

FIG. 1 is a front view of an example host device 100. Host device 100 is a smartphone which includes various components (e.g., similar to user device 300 as shown and described with respect to FIG. 3), including a processor, transceiver, memory, power source, a global positioning system (GPS) chipset, BluetoothTM chipset, and other peripherals (not shown), as well as a transmit/receive element 115, speaker/microphone 120, and a display/touchpad 130. It is noted that host device 100 may include other types of communications (or other) hardware such as a long range wireless data telemetry (LoRaTM) or long range wide area network (LoRaWAN™) chipset.

The implementation of host device 100 as a smartphone is exemplary. It is noted that host devices, such as host device 100, may be or include any suitable smartphone, tablet computer, GPS navigation device, feature phone, laptop computer, personal computer, or other computing and/or communication device capable of receiving location information from at least one client device 200, communicating location device to at least one client device 200 (FIG. 2), and/or displaying location information relating to at least one client device 200.

It is noted that instead of or in addition to the BluetoothTM and/or GPS chipset, host device 100 may include any suitable positioning hardware and/or software capable of determining the location of client device 200 geographically and/or relative to client device 200, such as LoRa™, RF, SONAR, WiFi, LTE direct™, WiFi direct™ or other direction finding and/or ranging hardware and/or software. Client device 200 may also include circuitry configured to determine its location without reference to external signals, or to determine its location in another way.

Host device 100 may be configured to communicate with one or more client devices (e.g., via an app). For example, host device 100 may include a host or server app which may pair with or otherwise serve a client app on client device 200. Host device 100 may include a BluetoothTM function which may pair with Bluetooth™ functionality on the client device 200. The server app may be stored in the memory, which may be a non-transitory computer readable medium, and may execute on the processor.

For example, host device 100 may be configured to receive location information via signals from or regarding at least one client device (such as client device 200). Host device 100 may determine a relative distance and direction to the client device based on such signals. The signal may include a Bluetooth™ beacon, LoRa™ or LoRaWAN™ signal, or any other suitable signal from which host device 100 may receive, determine, calculate or infer a relative distance and/or direction from the client device. Similarly, host device 100 may also be configured to transmit location information regarding its position, either to the client devices or to a proxy or intermediary. Host device 100 may transmit a signal to the client device from which the client device may receive, determine, calculate or infer a relative distance and/or direction from the host device. Host device 100 may also be configured to transmit and/or receive other information to, from, or regarding at least one client device. For example, host device 100 may transmit and/or receive voice, text, vibratory, or other alert messages to or from the client devices.

Host device 100 may use information received in such signals, or other signals, to establish its geographic position (e.g., a triangulated position based on signaling from two or more WiFi transmitters or GPS satellites), and may receive a geographic position (e.g., an absolute or relative position, or a triangulated position based on signaling from two or more WiFi transmitters or GPS satellites) of one or more client devices via signaling from the client devices, from an intermediary device, or from another device (e.g., a network device). Host device 100 may also determine its position without receiving such signals (e.g., by directly determining its position, inertial navigation, or other methods). The client devices may establish their position in a similar way, or in another way.

Host device 100 may determine a relative distance and direction of a client device from host device 100 based upon this location information. Distance and direction may include elevation, or elevation may be a separate element. For example, distance and direction may be calculated in a direct line from host device 100 to client device 200 (i.e., may include elevation). Distance and direction may alternatively be calculated exclusive of elevation. For example, distance and direction may be calculated to a point at ground level beneath or above client device 200, and the elevation (positive or negative may be calculated and/or expressed separately. Elevation of client device 200 may be expressed in terms of an absolute elevation, or relative to host device 100. For example, host device 100 may determine that client device 200 is on a particular floor of a building, or that client device 200 is at an elevation of 200 feet. Alternatively or additionally, host device 100 may use information received in such signals and/or the signals themselves to directly determine a relative distance and direction of a client device from host device 100 (e.g., via a directional antenna and/or signal delay measurements). Alternatively or additionally, host device 100 may determine a relative distance and/or direction from one or more clients using indoor positioning systems, magnetic positioning, compass readings, dead reckoning, deduced reckoning, inertial measurements, accelerometer readings, any combination of these, and/or any other suitable technique. Various techniques will be evident to those having skill in the art.

Display/touchpad 130 shows an example user interface for a tracking application executing on host device 100. The tracking application (which may be included in or in communication with the server app described above) may be stored in the memory, which may include a non-transitory computer readable medium, and may execute on the processor. The tracking application may receive data regarding the relative position of the client devices and host device 100 and may output this information to the user interface. The example user interface displays position indicators 150, 160, 170 representing three client devices (e.g., client device 200), and a position indicator 180 for the host device 100. It is noted that the number of tracked and displayed client device positions may be arbitrary, or may be constrained by the hardware and/or software capabilities of the host device 100. In some embodiments, elevation may also be indicated.

Position indicators 150, 160, 170, 180 indicate a relative distance and direction of each respective client device from the host device 100. If any of the client devices moves relative to the host device 100 (or if host device 100 moves relative to the client devices), position indicators 150, 160, 170 may be updated to reflect the new relative positions.

An identifier (e.g., a name) may be displayed next to each of the position indicators 150, 160, 170, as well as a text representation of the relative distance from each client device to the host device 100 measured in feet. The identifier may be received via signaling from the corresponding client device, may be associated with a respective position indicator by a user of the host device, or may otherwise be associated with a respective position indicator. It is noted that various permutations of the position indicators and accompanying text will be evident to those having skill in the art. For example, the relative distance measurement may be displayed in a different unit of measurement, or may be omitted entirely or selectively by the user.

The user interface may also display a boundary indication, such as range line 190. Range line 190 may indicate an area surrounding host device 100. Range line 190 may indicate a relative distance from host device 100 beyond which the client devices will be out of communications range with host device 100. Range line 190 may also or alternatively indicate an area beyond which the users of the client devices are not permitted to travel (e.g., a geofence). Range line 190 may be user defined (e.g., the user of host device 100 may set range line 190 arbitrarily to indicate an area beyond which users of client devices, or a particular client device or subset of client devices, may not travel.) For example, host device 100 may transmit a signal to a client device which has travelled beyond the range from host device 100 indicated by range line 190 to trigger client device 200 to express a vibration, beep, text message, or other alert. Host device 100 may also or alternatively express a similar alert if a client device travels beyond range line 190. An alert may also be triggered as a client device approaches the distance indicated by the range line 190, (e.g., within a given distance of the range line 190).

In addition, or alternatively, client devices may independently determine whether they have traveled beyond (or have come within a particular distance of) the range from host device 100 indicated by range line 190, and may generate an alert without the need for a signal from host device 100.

Client devices may also determine whether they have lost communication with the host device, and may generate an alert upon this condition. Various possible implementations will be evident to those having skill in the art. It is noted that range line 190 is shown as a partial circle having a radius of a given range from position indicator 180. However range line 190 may have an arbitrary shape and range (possibly constrained by operational limits of host device 100 and/or one or more client devices) defining an arbitrary area surrounding (or not surrounding) host device 100 and position indicator 180.

Host device 100 may be configured with one or more rally points (not shown). For example, instead of directing client device 200 toward host device 100, client device 200 may instead be directed toward an arbitrary rally point. Such rally points may be set by a user of host device 100, or of client device 200, for example. Alternatively, a rally point may be a last known location of host device 100 or client device 200. Host device 100 and/or client device 200 may each maintain a last known location of the other in a memory, for example.

In one example application, client device 200 may direct a user toward a rally point if client device 200 no longer has access to current location data for host device 100. In another example application, client device 200 may direct a user toward a rally point at a particular time, at any time, or under other conditions, which may be set by the user of client device 200 or host device 100.

Similarly, host device 100 may direct a user toward a rally point if host device 100 no longer has access to current location data for client device 200. In another example application, host device 100 may direct a user toward a rally point at a particular time, at any time, or under other conditions, which may be set by the user of client device 200 or host device 100.

FIG. 2 is a front view of an example client device 200. Client device 200 is a wrist-worn device which includes various components similar to user device 300, including a processor, transceiver, transmit/receive element, speaker/microphone, memory, power source, a global positioning system (GPS) chipset, Bluetooth™ chipset, and other peripherals (not shown), as well as a display 230. Client device 200 may be water-resistant, and may also include a button 240 for interacting with various functions. It is noted that client device 200 may include other types of communications (or other) hardware, such as a long range wireless data telemetry (LoRa™) or long range wide area network (LoRaWAN™) chipset.

The implementation of client device 200 as a wrist-worn device is exemplary. It is noted that client devices, such as client device 200, may be or include a smart watch, smartphone, tablet computer, GPS navigation device, feature phone, laptop computer, personal computer, or any suitable computing and/or communication device capable of receiving location information from at least one host device 100, communicating location device to at least one host device 100, and/or displaying location information relating to at least one host device 100.

It is noted that instead of or in addition to the BluetoothTM and/or GPU chipset, client device 200 may include any suitable positioning hardware and/or software capable of determining the location of client device 200 geographically and/or relative to host device 100, such as LoRa™, RF, SONAR, WiFi, LTE direct™, WiFi directTM or other direction finding and/or ranging hardware and/or software. Client device 200 may also include circuitry configured to determine its location without reference to external signals, or to determine its location in another way.

Client device 200 may be configured to communicate with one or more client devices (e.g., via an app). For example, client device 200 may include a client app which may pair with or otherwise serve a host or server app on host device 100. Client device 200 may include a Bluetooth™ function which may pair with Bluetooth™ functionality on the host device 100. The client app may be stored in the memory, which may be a non-transitory computer readable medium, and may execute on the processor.

For example, client device 200 may be configured to receive location information via signals from or regarding at least one host device (such as host device 100). Client device 200 may determine a relative distance and direction to the host device based on such signals. The signal may include a Bluetooth™ beacon, LoRa™ or LoRaWAN™ signal, or any other suitable signal from which client device 200 may receive, determine, calculate or infer a relative distance and/or direction from the host device. Similarly, client device 200 may also be configured to transmit location information regarding its position, either to the host device or to a proxy or intermediary. Client device 200 may transmit a signal to the host device from which the host device may calculate or infer a relative distance and/or direction from the client device. Client device 200 may also be configured to transmit and/or receive other information to, from, or regarding at least one host device. For example, client device 200 may transmit and/or receive voice, text, or alert messages to or from the host device.

Client device 200 may use information received in such signals, or other signals, to establish its geographic position (e.g., an absolute or relative position communicated by host device 100, or a triangulated position based on signaling from two or more WiFi transmitters or GPS satellites), and may receive a geographic position (e.g., an absolute or relative position communicated by host device 100, or a triangulated position based on signaling from two or more WiFi transmitters or GPS satellites) of a host device via signaling from the host device, from an intermediary device, or from another device (e.g., a network device). Host device 100 may also determine its position without receiving such signals (e.g., by directly determining its position, inertial navigation, or other methods). The host device may establish its position in a similar way, or in another way.

Client device 200 may determine a relative distance and direction of a host device from client device 200 based upon this location information. Distance and direction may include elevation, or elevation may be a separate element. For example, distance and direction may be calculated in a direct line from client device 200 to host device 100 (i.e., may include elevation). Distance and direction may alternatively be calculated exclusive of elevation. For example, distance and direction may be calculated to a point at ground level beneath or above host device 100, and the elevation (positive or negative may be calculated and/or expressed separately. Elevation of host device 100 may be expressed in terms of an absolute elevation, or relative to client device 200. For example, client device 200 may determine that host device 100 is on a particular floor of a building, or that host device is at an elevation of 200 feet. Alternatively or additionally, client device 200 may use information received in such signals and/or the signals themselves to directly determine a relative distance and direction of a host device from client device 200 (e.g., via a directional antenna and/or signal delay measurements). Alternatively or additionally, client device 200 may determine a relative distance and/or direction from one or more clients using indoor positioning systems, magnetic positioning, compass readings, dead reckoning, deduced reckoning, inertial measurements, accelerometer readings, any combination of these, and/or any other suitable technique. Various techniques will be evident to those having skill in the art.

Display 230 shows an example user interface for a tracking application executing on client device 200. The example user interface displays a position indicator 250 representing client device 200 and a position indicator 280 representing a direction and/or distance to a host device (e.g., host device 100). If client device 200 moves relative to the host device, position indicators 250 and 280 may update to reflect the new relative positions. For example, indicator 280 is shown as an arrow, and indicator 280 may rotate to indicate an updated direction toward the host device 100. Indicator 280 may also change in length to graphically indicate an increasing or decreasing distance toward host device 100. In some embodiments, elevation may also be indicated.

Indicator 280 may thus have the advantage of directing a user of client device 200 in a direction toward host device 100 in an easily understand way.

An identifier for the host device 100 may be received and displayed on display 230 in a manner analogous to the identifiers displayed for client devices on host device 100 as described in more detail above.

Client device 200 may also provide a visual, audio, vibration, or other alert to a user if client device 200 moves beyond a designated area. For example, if a user of host device 100 has defined a range line 190 as discussed above, a user of client device 200 may receive an alert notification that the range has been exceeded, or is being approached. It is noted that if the range is defined relative to host device 100 (or another mobile object such as another client device or other beacon) then the client device may approach the range without moving (e.g., the host device 100 moves relative to client device 200).

Client device 200 may receive a signal from host device 100 if it has travelled beyond a particular range, (e.g., a range from host device 100 indicated by range line 190) to trigger client device 200 to express a vibration, beep, text message, or other alert. Client device 200 may also or alternatively be aware of the range (e.g., having received this information from host device 100 or having been programmed with this information) and may express an alert on its own if it approaches or exceeds the range. Host device 100 may also or alternatively express a similar alert if a client device travels beyond the given range. An alert may also be triggered to be expressed by client device 200 (e.g., via a signal from host device 100, an intermediary or other device, or by client device 200 itself) and/or by host device 100 (e.g., via a signal from client device 200, an intermediary or other device, or by host device 100 itself) as a client device approaches the boundary of the given range (e.g., the distance indicated by the range line 190, or within a given distance of the range line 190).

In addition, or alternatively, client devices may independently determine whether they have traveled beyond (or have come within a particular distance of) the range from host device 100 indicated by range line 190, and may generate an alert without the need for a signal from host device 100.

Client devices may also determine whether they have lost communication with the host device, and may generate an alert upon this condition. Various possible implementations will be evident to those having skill in the art. It is noted that range line 190 is shown as a partial circle having a radius of a given range from position indicator 180. However range line 190 may have an arbitrary shape and range (possibly constrained by operational limits of host device 100 and/or one or more client devices) defining an arbitrary area surrounding (or not surrounding) host device 100 and position indicator 180.

Client device 200 may be configured with one or more rally points (not shown). For example, instead of directing client device 200 toward host device 100, client device 200 may instead be directed toward an arbitrary rally point. Such rally points may be set by a user of host device 100, or of client device 200, for example. Alternatively, a rally point may be a last known location of host device 100 or client device 200.

In one example application, client device 200 may direct a user toward a rally point if client device 200 no longer has access to current location data for host device 100. In another example application, client device 200 may direct a user toward a rally point at a particular time, at any time, or under other conditions, which may be set by the user of client device 200 or host device 100.Host device 100 and/or client device 200 may each maintain a last known location of the other in a memory, for example.

Similarly, host device 100 may direct a user toward a rally point if host device 100 no longer has access to current location data for client device 200. In another example application, host device 100 may direct a user toward a rally point at a particular time, at any time, or under other conditions, which may be set by the user of client device 200 or host device 100.

It is noted that in various implementations a host device, such as host device 100, may have a user interface similar to that described with respect to client device 200. It is likewise noted that in various implementations a client device, such as client device 200, may have a user interface similar to that described with respect to host device 100.

Client device 200 may have the general form of a wristwatch and may include a strap 210 for securing the client device 200 to a wrist or other object. In various implementations, client devices such as client device 200 may have other suitable forms, and also or alternatively may be securable to an article of clothing or a lanyard for example.

In some implementations, strap 210 may be configured with a locking mechanism such that it may only be removed by an authorized user, such as using a standard or magnetic key for example. In some implementations, strap 210 may be configured with an alert mechanism (not shown) which triggers an alert in client device 200 which is transmitted to host device 100 if strap 210 is cut or removed in an unauthorized manner, such as without a proper key for example.

FIG. 3 is a system diagram of an example user device 300 in which one or more disclosed embodiments may be implemented. User device 300 may be a host device, such as host device 100, or a client device, such as client device 200 for example.

As shown in FIG. 3, the user device 300 may include a processor 305, a transceiver 310, a transmit/receive element 315, a speaker/microphone 320, a keypad 325, a display/touchpad 330, memory 335, a power source 340, a global positioning system (GPS) chipset 345, and other peripherals 350. It will be appreciated that the user device 300 may include any sub-combination of the foregoing elements while remaining consistent with an embodiment.

The processor 305 may include a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 305 may perform signal coding, data processing, power control, input/output processing, and/or any other functionality that enables the user device 300 to operate in a wireless environment. The processor 305 may be coupled to the transceiver 310, which may be coupled to the transmit/receive element 315. While FIG. 3 depicts the processor 305 and the transceiver 310 as separate components, it will be appreciated that the processor 305 and the transceiver 310 may be integrated together, for example, in an electronic package or chip.

The transmit/receive element 315 may be configured to transmit signals to, or receive signals from, a base station, bridge device, and/or another user device over an air interface. For example, in one embodiment, the transmit/receive element 315 may include an antenna configured to transmit and/or receive radio frequency (RF) signals. In another embodiment, the transmit/receive element 315 may include an emitter/detector configured to transmit and/or receive infrared (IR), ultraviolet (UV), or visible light signals, for example. In yet another embodiment, the transmit/receive element 315 may be configured to transmit and receive both RF and light signals. It will be appreciated that the transmit/receive element 315 may be configured to transmit and/or receive any combination of wireless signals. For example, if user device 300 is a host device (such as host device 100) transmit/receive element 315 may transmit signals to a client device (such as client device 200) either directly or indirectly through an intermediary. Similarly, if user device 300 is a client device (such as client device 200) transmit/receive element 315 may transmit signals to a host device (such as host device 100) either directly or indirectly through an intermediary.

In addition, although the transmit/receive element 315 is depicted in FIG. 3 as a single element, the user device 300 may include any number of transmit/receive elements 315. More specifically, the user device 300 may employ multiple-input-multiple-output (MIMO) technology. Thus, in one embodiment, the user device 300 may include two or more transmit/receive elements 315 (e.g., multiple antennas) for transmitting and receiving wireless signals over the air interface.

The transceiver 310 may be configured to modulate signals that may be to be transmitted by the transmit/receive element 315 and to demodulate signals that may be received by the transmit/receive element 315. As noted above, the user device 300 may have multi-mode capabilities. Thus, the transceiver 310 may include multiple transceivers for enabling the user device 300 to communicate via multiple radio access technologies (RATs), such as UTRA and IEEE 802.11, for example.

The processor 305 of the user device 300 may be coupled to, and may receive user input data from, the speaker/microphone 320, the keypad 325, and/or the display/touchpad 330 (e.g., a liquid crystal display (LCD) display unit or organic light-emitting diode (OLED) display unit). The processor 305 may also output user data to the speaker/microphone 320, the keypad 325, and/or the display/touchpad 330. In addition, the processor 305 may access information from, and store data in, any type of suitable memory 335, such as a non-removable memory and/or the removable memory. Memory 335 may include random-access memory (RAM), read-only memory (ROM), a hard disk, or any other type of memory storage device. The memory 335 may also or alternatively include a subscriber identity module (SIM) card, a memory stick, a secure digital (SD) memory card, and the like. In other embodiments, the processor 305 may access information from, and store data in, memory that may be not physically located on the user device 300, such as on a server or a home computer (not shown).

The processor 305 may receive power from the power source 340, and may be configured to distribute and/or control the power to the other components in the user device 300. The power source 340 may be any suitable device for powering the user device 300. For example, the power source 340 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 305 may also be coupled to the GPS chipset 345, which may be configured to provide location information (e.g., longitude and latitude, elevation, and/or a relative distance from another user device) regarding the current location of the user device 300. In addition to, or in lieu of, the information from the GPS chipset 345, the user device 300 may receive location information over the air interface from a base station, bridge device, or other user device (not shown) and/or determine its location based on the timing of the signals being received from two or more nearby base stations. It will be appreciated that the user device 300 may acquire location information by way of any suitable location-determination method while remaining consistent with an embodiment.

The processor 305 may further be coupled to other peripherals 350, which may include one or more software and/or hardware modules that provide additional features, functionality and/or wired or wireless connectivity. For example, the peripherals 350 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

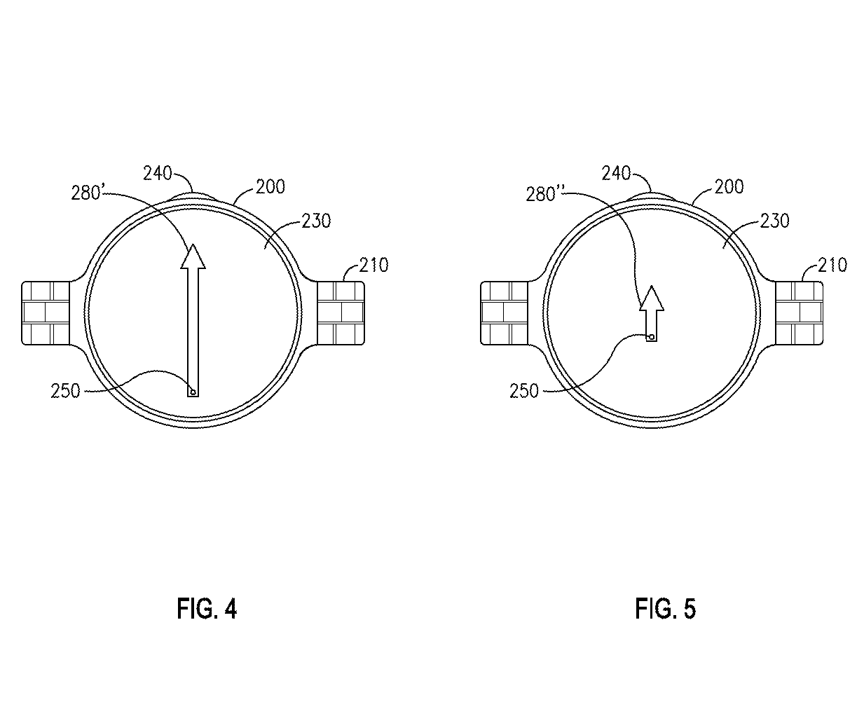

FIGS. 4 and 5 illustrate client device 200 showing a lengthened indicator 280′ and a shortened indicator 280″ respectively. Indicator 280′ may be longer than indicator 280 to indicate a larger distance from the host device 100 as compared with indicator 280 (e.g., after receiving and processing a position update). Indicator 280″ may be shorter than indicator 280 to indicate a shorter distance from the host device 100 as compared with indicator 280.

In the example of client device 200, a text representation (not shown) of the relative distance to the host device 100 may be displayed. It is noted that various permutations of the position indicator and any accompanying text are possible. For example, a relative distance measurement may be displayed in a different unit of measurement, or may be omitted entirely or selectively by the user. In other implementations, indicator 280 may have a form other than an arrow or pointer. For example, the indicator may have a form substantially similar to the arrangement of indicators 150 and 180 as shown and described with respect to host device 100 (FIG. 1).

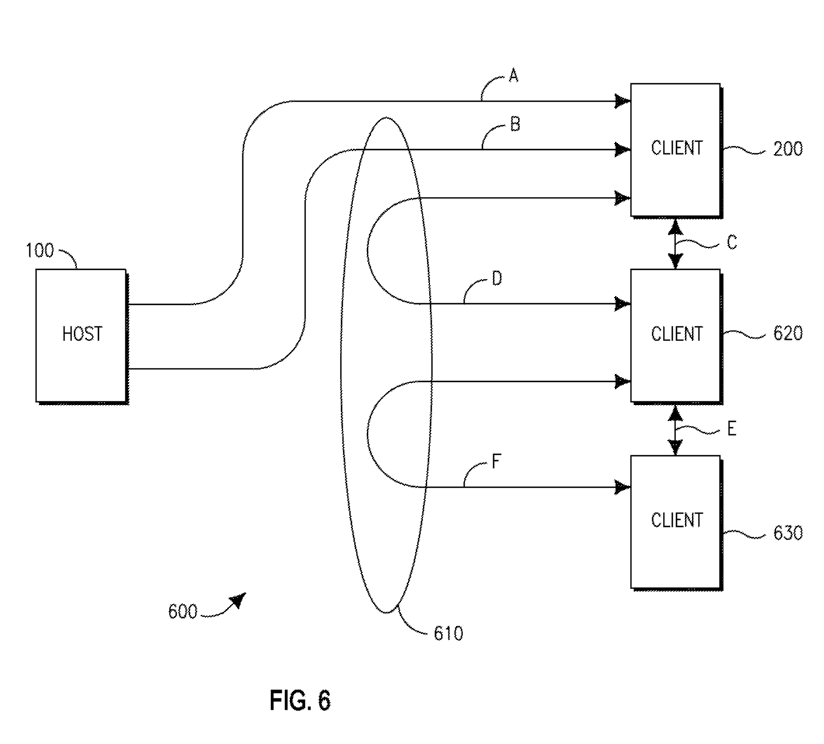

FIG. 6 is a system diagram of an example communications system 600 in which one or more disclosed embodiments may be implemented. Communications system 600 illustrates various ways in which host device 100 may communicate with a client device (e.g., client device 200).

As shown in FIG. 6, host device 100 may communicate directly with client device 200 via a wireless link A, or via a computer communications network 610 as shown by link B. Computer communications network may include any suitable network such as a WiFi, Bluetooth, LTE, LoRa™, LoRaWAN™, cellular telephone network, a personal area network (PAN), the Internet or any portion thereof, or any combination of these or other suitable communications networks.

Host device 100 may also communicate indirectly with client devices. For example, host device 100 may communicate with client device 620 via client device 200. This communication may follow various paths, such as A-C, B-C, A-D or B-D. In this example, link C is a direct peer-to-peer wireless link between client 200 and client 620, and link D is a wireless link between client 200 and client 620 over network 610. Similarly, host device 100 may communicate with client device 630 via client 200 and client 620. This communication may follow various paths, such as A-C-E, A-C-F, A-D-E, A-D-F, B-C-E, B-C-F, B-D-E, or B-D-F. In this example, link E is a direct peer-to-peer wireless link between client 620 and client 630, and link D is a wireless link between client 620 and client 630 over network 610. Those having skill in the art will understand that there are numerous possible networked, peer-to-peer, and combinations of networked and peer-to-peer topologies which may be possible. For example, in some embodiments, client devices 200, 620, and/or 630 may form a network, such as a peer-to-peer network, and such network may have a mesh topology, a star topology using user device 200 as a coordinating node, or any other suitable topology.

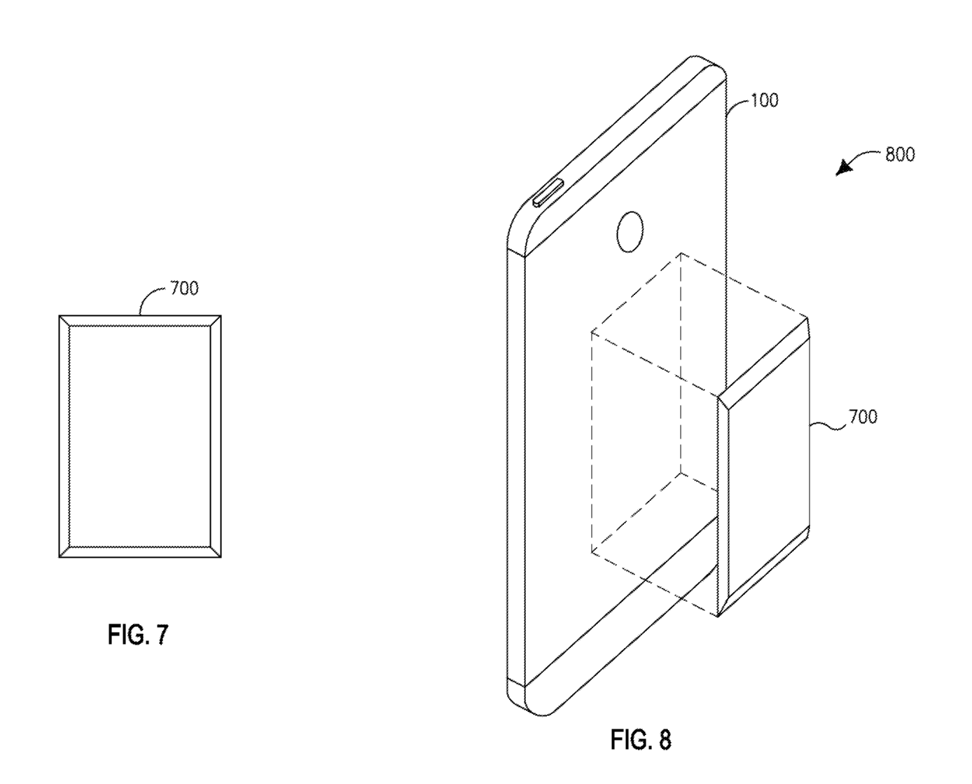

FIG. 7 is a plan view of an example bridge device 700 according to aspects of the invention. Bridge device 700 may include a power source (e.g., a battery), one or more radio transceivers, and one or more antennas configured to receive and transmit signals from and to a host device (e.g., host device 100) and one or more client devices (e.g., client device 200).

Bridge device 700 may provide a communications bridge between a smart device, such as host device 100, and new or other wireless technologies (e.g., technologies with which host device 100 is not configured to communicate.) For example, various emerging technologies, such as LoRaWANN™, indoor WiFi location, or ultrawideband, may eventually be incorporated into newer smartphones or tablets, but it may be desirable to provide a bridge device such that current smartphones which are not so equipped may take advantage of these new technologies.

In some implementations of communications system 600, client devices may include hardware and/or software to communicate via communications standards to which host device 100 does not conform. Bridge device 700 may thus be configured to facilitate heterogeneous wireless communications between host device 100 and client devices. For example, if client devices 200, 620, and 630 include circuitry and/or software configured to communicate using LoRa™ LoRaWAN™, RuBee™, or another suitable peer-to-peer communications standard, while host device 100 does not, bridge device 700 may be configured to relay signals between host device 100 and one or more of the client devices 200, 620, 630. To facilitate the relay, bridge device 700 may communicate with host device 100 via a Bluetooth™ link, and may communicate with client device 200 via a LoRa™ or LoRaWAN™ link, for example, converting the respective signals or otherwise bridging communications between these standards. It is noted that LoRa™, LoRaWAN™ and Bluetooth™ are exemplary, and various other communications standards and procedures could be used, as will be evident to those having skill in the art.

In some implementations, bridge device 700 includes a LoRa™ or LoRaWANN™ gateway, and client and/or host devices may include a corresponding LoRa™ or LoRaWANN™ end point. LoRa™ technology may be employed to use low frequency radio bands to transmit signals from a gateway device to end points, which may communicate with each other. These end points may perform various functions based upon information sent from a host device or app. Bridge device 700 may thus incorporate a LoRa™ gateway and/or other technology (e.g., WiFi, GPS, Bluetooth, etc.) which may communicate with an app running on a smart device (e.g., host device 100) using Bluetooth™ and may pass information from the app to the end point (e.g., client device 200) using LoRa™. Bridge device 700 may include one or more integrated circuits implementing the LoRa™ stack, Bluetooth™, GPS™, or other associated technologies. Bridge device 700 may include one or more antennas necessary for communications using LoRa™, Bluetooth™ and/or GPS™. In some implementations, bridge device 700 may be modifiable to communicate via other communications standards by swapping or adding one or more of integrated circuits or antennas specific to such standards. Such integrated circuits may also be updatable, e.g., via a firmware update.

FIG. 8 is an exploded assembly diagram showing an example assembly 800 of bridge device 700 and host device 100. Bridge device 700 may be affixed to device 700 as shown in any suitable manner, such as a removable or permanent adhesive, suction cup, hook-and-loop attachment, or otherwise. Bridge device 700 may be affixed to host device 100 such that it may communicate wirelessly with host device 100 and client devices (e.g., client device 200). In some implementations, Bridge device 700 and host device 100 may communicate via a wired connection. In some implementations, bridge device 700 may be integrated into a case for host device 100, which may include an integrated wired connection between bridge device 700 and host device 100. It is noted that in some implementations bridge device 700 and host device 100 may not be assembled, and may function via a wireless connection without being physically attached to one another.

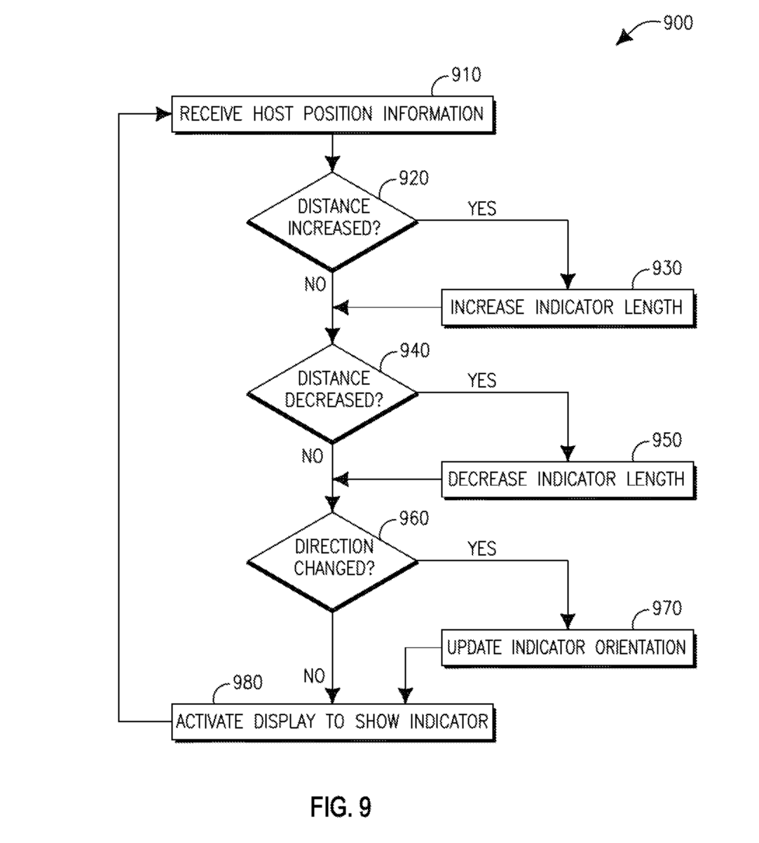

FIG. 9 is a flow chart 900 illustrating an example method for guiding a client device user toward a host device using an indicator which reflects a distance and a direction toward the host device.

In step 910, a client device receives host position information, such as described herein. On a condition 920 that the distance between the client device and the host device has increased since the last update, the client device increases a length of the indicator in step 930. On a condition 940 that the distance between the client device and the host device has decreased since the last update, the client device decreases a length of the indicator in step 950. On a condition that a direction from the client device to the host device has changed, the client device updates the indicator orientation. The client device then activates a display to show the indicator in step 980. This process may continue throughout the operation of the client device.

It is noted that the various devices, systems, and methods described herein are not limited to any particular context, and may have varied applicability. For example, those skilled in the art will readily appreciate that these technologies will find applicability in such diverse fields as employee monitoring (e.g., where host device 100 can track the location of an employee wearing client device 200), pet fencing (e.g., where host device 100 can define a range line 190 outside which a pet will receive a shock from a shock collar integrated with client device 200), fleet monitoring (e.g., where host device 100 can track vehicles integrating client device 200), ad-hoc private wireless networks (e.g., where client device 200 can communicate with other client devices and with host device 100 using heterogeneous communications via bridge device 700), remote control of various electronic devices (e.g., where host device 100 can control a device incorporating client device 200 via bridge device 700), and premium entry to theme parks (e.g., where host device 100 can provide location based access privileges for a user of client device 200), for example.

Although features and elements may be described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but may be not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A system for guiding a client device user toward a host device, comprising:
a host device comprising a first wireless transceiver and a first display;
a client device comprising a second wireless transceiver, a second display, and an attachment mechanism;
the host device in wireless communication with the client device over a communications channel;
the host device further comprising circuitry configured to receive, via the first wireless transceiver, first position data regarding a client device position, wherein the host device further comprises circuitry configured to activate the first display, in response to the first position data being received by the host device, to show an indication of the client device on the display which indicates a relative direction and distance of the client device from the host device based on the first position data;
the client device further comprising circuitry configured to receive, via the second wireless transceiver, second position data regarding a host device position, wherein the client device further comprises circuitry configured to activate the second display, in response to the second position data being received by the client device, to show an indication of a relative direction and distance of the host device from the client device based on the second position data;
wherein the indication of the relative direction and distance of the host device from the client device comprises a pointer having an orientation toward the host device and a length corresponding to a relative distance between the client device and the host device;
the client device further comprising circuitry configured to activate the display, in response to the second position data indicating a change in the relative direction of the host device from the client device, to change an orientation of the pointer toward the host device; and,
the client device further comprising circuitry configured to activate the display, in response to the second position data indicating a change in the relative distance of the host device from the client device, to change a length of the pointer, wherein the length is decreased if the relative distance is decreased and wherein the length is increased if the relative distance is increased.

2. The system of claim 1, wherein the client device further comprises an attachment strap and circuitry configured to activate an alert on a condition that the attachment strap is unfastened, broken, or cut; wherein the alert is transmitted via the second wireless transceiver to the host device.

3. The system of claim 1, wherein the client device further comprises circuitry configured to receive a text or audio message and to activate, in response to receiving a text or audio message, to display or play the text or audio message.

4. The system of claim 1, wherein the host device further comprises circuitry configured to activate the first display, in response to the first position data indicating a change in the relative direction or relative distance of the client device from the host device, to change a location of the indication of the client device on the first display.

5. The system of claim 1, wherein the host device further comprises:
circuitry configured to activate the first display to show a boundary indication, wherein the boundary indication indicates a range; and
circuitry configured to activate an alert, in response to the first position data indicating that the client device exceeds the range from the host device;
wherein the alert comprises an audio, vibratory, or text alert displayed on the host device or the client device.

6. The system of claim 1, further comprising a bridge device, the bridge device comprising a third wireless transceiver configured to receive first signals from the host device in a first format, to generate second signals in a second format based on the first signals, and to transmit the second signals to the client device.

7. The system of claim 1, wherein the host device further comprises circuitry configured to activate the first display, in response to the first position data being received by the host device, to show an indication of an elevation of the client device based on the first position data; and wherein the client device further comprises circuitry configured to activate the second display, in response to the second position data being received by the host device, to show an indication of an elevation of the host device.

8. A device for guiding a client device user toward a host device, comprising:
an antenna, a non-transitory computer readable medium, and a display;
wireless transceiver circuitry configured to communicate with a host device via the antenna over a communications channel;
positioning circuitry configured to receive host device position information,
wherein the positioning circuitry is further configured to activate the display, in response to receiving the host device position information, to display an indicator representing a relative direction and distance of the host device from the client device on the display based on the host device position information, and
wherein the indicator comprises a pointer having an orientation in a direction toward the host device and a length corresponding to a relative distance between the client device and the host device.

9. The device of claim 8, wherein the host position information is received over the communication channel.

10. The device of claim 8, further comprising:
circuitry configured to activate the display, in response to the host device position information indicating a change in a relative direction of the host device from the client device, to change an orientation of the pointer toward the host device; and,
the client device further comprising circuitry configured to activate the display, in response to the host device position information indicating a change in the relative distance between the host device and the client device, to change a shape of the pointer.

11. The device of claim 10, wherein changing the shape of the pointer comprises changing a length of the pointer, wherein the length is decreased if the relative distance is decreased and wherein the length is increased if the relative distance is increased.

12. The device of claim 8, further comprising an attachment strap and circuitry configured to activate an alert on a condition that the attachment strap is unfastened, broken, or cut; wherein the alert is transmitted to the host device.

13. The device of claim 8, further comprising circuitry configured to receive a text or audio message and to activate, in response to receiving a text or audio message, to display or play the text or audio message.

14. The device of claim 8, further comprising:
circuitry configured to determine, based on the host device position information, whether the device exceeds a distance from the host device; and
circuitry configured to activate an alert, in response to the host position information, indicating that the client device exceeds the distance from the host device.

15. The device of claim 14, further comprising circuitry configured to transmit the alert, via the transceiver, to the host device.

16. The device of claim 14, wherein the alert comprises an audio, vibratory, or text alert displayed client device.

17. The device of claim 8, further comprising circuitry configured to activate the display, in response to the host device position information, to show an indication of an elevation of the host device based on the host device position information.

18. A method for guiding a client device user toward a host device, comprising:
receiving, by positioning circuitry of a client device, position information regarding a position of a host device;
activating a display of the client device, in response to receiving the position information, to display an indicator representing a direction toward the host device and distance between the host device and the client device based on the position information;
wherein the indicator comprises a pointer having an orientation in the direction toward the host device and a length corresponding to the distance between the host device and the client device.

19. The method of claim 18, further comprising activating the display, in response to the position information indicating a change in the direction toward the host device, to change an orientation of the pointer toward the host device; and
activating the display, in response to the position information indicating a change in the distance between the host device and the client device, to change a shape of the pointer.

20. The method of claim 19, wherein changing the shape of the pointer comprises changing a length of the pointer, wherein the length is decreased if the distance between the host device and the client device is decreased and wherein the length is increased if the distance between the host device and the client device is increased.

21. The method of claim 18, further comprising determining, based on the position information, whether the client device exceeds a distance from the host device; and activating an alert, in response to a condition that the client device exceeds the distance from the host device.

22. The method of claim 18, further comprising transmitting position information regarding a position of the client device to the host device via a bridge device.

23. The method of claim 18, further comprising activating a display of the client device, in response to receiving the position information, to show an indication of an elevation of the host device based on the host device position information.
